(19) United States
(12) Patent Application Publication
(10) Pub. No.: US 2020/0174482 A1
(43) Pub. Date: Jun. 4, 2020

(54) ONLINE BIDIRECTIONAL TRAJECTORY PLANNING METHOD IN STATE-TIME SPACE, RECORDING MEDIUM STORING PROGRAM FOR EXECUTING SAME, AND COMPUTER PROGRAM STORED IN RECORDING MEDIUM FOR EXECUTING SAME

(71) Applicant: TWINNY Co., Ltd., Daejeon (KR)

(72) Inventors: Hongseok CHEON, Daejeon (KR); Taehyoung KIM, Daejeon (KR); Yongjin BYEON, Daejeon (KR); Jaihoon LEE, Daejeon (KR)

(21) Appl. No.: 16/679,357

(22) Filed: Nov. 11, 2019

(30) Foreign Application Priority Data
Nov. 29, 2018 (KR) 10-2018-0151119

(51) Int. Cl. G05D 1/02

(52) U.S. Cl. CPC G05D 1/0214; G05D 1/0088

(57) ABSTRACT

The present invention relates to an online bidirectional trajectory planning method in a state-time space, a recording medium storing a program for employing the same, and a computer program stored in a medium for employing the same. More particularly, the present invention relates to an online bidirectional trajectory planning method in a state-time space, a recording medium storing a program for employing the same, and a computer program stored in a medium for employing the same, wherein autonomous driving is available while over-run or vibration does not occur in a robot by planning a bidirectional trajectory using a forward trajectory and a backward trajectory.

### CROSS REFERENCE TO RELATED APPLICATION

The present application claims priority to Korean Patent Application No. 10-2018-0151119, filed Nov. 29, 2018, the entire contents of which is incorporated herein for all purposes by this reference.

### TECHNICAL FIELD

The present invention relates to an online bidirectional trajectory planning method in a state-time space, a recording medium storing a program for employing the same, and a computer program stored in a medium for employing the same. More particularly, the present invention relates to an online bidirectional trajectory planning method in a state-time space, a recording medium storing a program for employing the same, and a computer program stored in a medium for employing the same, wherein autonomous driving is available while over-run or vibration does not occur in a robot by planning a bidirectional trajectory using a forward trajectory and a backward trajectory.

### BACKGROUND

Autonomous driving robots refer to robots that search for their own surroundings and detect obstacles while searching for the optimal trajectory to a destination by using wheels or legs thereof.

Trajectory planning and obstacle avoidance are major techniques in autonomous driving of moving robots. Robots have to generate a trajectory to a destination and move to the destination without colliding with the surrounding obstacles. A good trajectory means the shortest trajectory where a movement trajectory to a destination is minimum, or a safe trajectory where collisions with surrounding obstacles are minimum.

Generally, safe trajectories are more important in the application field of robot. However, the optimal trajectory may be the shortest while being the safest.

Generally, as a method of ensuring a safe trajectory, there is used a method of determining a direction where an empty space is large by using obstacle detecting sensors installed in the robot (devices measuring a distance with nearby obstacles, such as laser or ultrasonic waves, etc.) and determining a movement direction of robot by taking into account a direction to a destination. Weighting factors for a direction to an empty space and for a direction to a destination are determined experimentally. When a large weighting factor is given to an empty space, collision with surrounding obstacle may be minimized, but a long trajectory may be obtained, and in extreme cases, the robot may not get to the destination. On the contrary, when a large weighting factor is given to a destination, safety is degraded.

A fundamental driving performance of an autonomous driving robot is an intelligent navigation capability of moving along an optimal trajectory to a destination without collisions. For the intelligent navigation capability, a trajectory planning technique and a location recognition technique are required.

Herein, the trajectory planning technique may be classified into global trajectory planning and local trajectory planning.

First, global trajectory planning means searching for an optimal trajectory to a target point by using a given environmental map, and local trajectory planning means avoiding obstacles in real time under a dynamic environment.

In addition, the location recognition technique is a location determining technique where a current location of a robot that is navigating is determined on a map.

As a conventional example of the above global trajectory planning method, typically, for example, a “Dijkstra algorithm” is known which is disclosed in a note on two problems in connexion with graphs (E. W. Dijkstra, Numerische Mathematik, Volume 1, Number 1, 269-271, 1959)”.

In detail, the Dijkstra algorithm is provided as initial trajectory planning and is widely used in various fields up to now. However, a lot of calculation time is required since the algorithm performs searching in all the spaces.

In addition, as another conventional example of the above global trajectory planning method, for example, an A* algorithm is provided that is disclosed in “A Formal Basis for the Heuristic Determination of Minimum Cost Paths in Graphs_A star (PETER E. HART, VOL. ssc-4, NO 2, 1968)”.

In detail, the A* algorithm is a complement to the Dijkstra algorithm, and a searching time is faster than the Dijkstra algorithm by adding an evaluating function on the basis of depth first search and breadth first search. However, real time calculation for the same is difficult.

In order to enable real time calculation, an incremental planning method is used where a trajectory is planned by designating a waypoint through which a robot passes.

An incremental planning method enables fast calculation, but an over-run phenomenon occurs where a turning trajectory becomes large when the robot turns on the target waypoint and then turns toward the next target waypoint as a distance between waypoints is short or an angle between waypoints is small.

In Korean Patent No. 10-1079197, a method of tracking a trajectory of an autonomous driving device is disclosed.

### SUMMARY

Accordingly, the present invention has been made keeping in mind the above problems occurring in the related art, and an objective of the present invention is to provide an online bidirectional trajectory planning method in a state-time space, a recording medium storing a program for employing the same, and a computer program stored in a medium for employing the same, wherein autonomous driving is available while over-run or vibration does not occur in a robot by planning a bidirectional trajectory using a forward trajectory and a backward trajectory.

Technical tasks obtainable from the present invention are non-limited the above-mentioned technical task, and other unmentioned technical tasks can be clearly understood from the following description by those having ordinary skill in the technical field to which the present invention pertains.

In order to achieve the above object, according to one aspect of the present invention, there is provided an online bidirectional trajectory planning method in a state-time space, wherein the method is employed in a program form executed by an arithmetic processing means including a computer, the method including: planning a bidirectional trajectory on the basis of a forward trajectory calculation in a state-time space which is from a current location of a robot or a last calculation point of a forward trajectory to a current target waypoint or a last calculation point of a backward trajectory by taking into account a state value (s) and a time value, and a backward trajectory calculation in the state-time space which is from the current target waypoint or a last calculation point of the backward trajectory to the current location of the robot or the last calculation point of the forward trajectory, wherein the forward trajectory and the backward trajectory are incrementally planned, wherein a state value (sₙ) (n represents a time index, and is a natural number)) in the state-time space, which is used when planning the forward trajectory and the backward trajectory, includes a configuration value of a location and a bearing (heading angle), and includes any one or a plurality of pieces of information selected from a steering angle, a velocity, and an acceleration.

In addition, in the forward trajectory calculation and the backward trajectory calculation, a cost-to-go function (H) is decomposited, and a priority r (r is natural number) is assigned to each decomposited cost-to-go function (H^{r}), and the decomposited cost-to-go functions (H^{r}) are applied according a preset reference (an r* value may be set or calculated) to a near-optimal timed state function (N) which calculates a trajectory such that a value of summing the decomposited cost-to-go functions (H^{r}) become minimum, wherein a state value (sₙ₊ₘ) from a point where a state value (sₙ) is given to a target point is calculated where the calculation is performed for a number (m) of steps on the basis of the state value (sₙ) given in an n step, a state value (s^{to}) at the target point, and the number (m) of steps to be calculated.

In addition, in the forward trajectory calculation and the backward trajectory calculation, a cost-to-go function (H) is decomposited, and a priority r (r is a natural number) is assigned to each decomposited cost-to-go function (H^{r}), and the decomposited cost-to-go functions (H^{r}) are sequentially applied according to a priority (an r* value may be set or calculated) to a near-optimal timed state function (N) which calculates a trajectory such that each value of the decomposited cost functions (H) become minimum, wherein a state value (sₙ₊ₘ) from a point where a state value (sₙ) is given to a target point is calculated where the calculation is performed for a number (m) of steps on the basis of the state value (sₙ) given in an n step, a state value (s^{to}) at the target point, and the number (m) of steps to be calculated.

In addition, in the forward trajectory calculation, when a safe timed configuration region Qₙ^{safe} (m) exists which is a space within a configuration region where collisions with static obstacles and dynamic obstacles are not present, the forward trajectory is calculated on the basis of a configuration value (qₙ) of the robot a time index (n) and the safe timed configuration region Qₙ^{safe} (m) at the time index (n), and in the backward trajectory calculation, when the safe timed configuration region exists, the backward trajectory is calculated on the basis of the configuration value (qₙ) of the robot at the time index (n) and the safe timed configuration region Qₙ^{safe} (m).

In addition, the planning of the bidirectional trajectory includes: S20 of setting a robot state in a current target waypoint; S30 of calculating the backward trajectory; S50 of calculating the forward trajectory; and S60 of generating a command for controlling the robot according to the bidirectional trajectory when the S30 of calculating the backward trajectory and the S50 of calculating the forward trajectory are repeated a preset number of times.

In addition, the online bidirectional trajectory planning method in a state-time space may further include: calculating a connection trajectory connecting the forward trajectory and the backward trajectory, wherein the bidirectional trajectory is planned by incrementally planning the forward trajectory and the backward trajectory after the calculating of the connection trajectory.

In addition, the planning of the bidirectional trajectory includes: S20 of setting a robot state in a current target waypoint; S30 of calculating the backward trajectory; S40 of determining whether or not the connection trajectory exists where the current location of the robot or the last calculation point of the forward trajectory is connected to the current target waypoint or the last calculation point of the backward trajectory; S50 of calculating the forward trajectory when the connection trajectory does not exist; and S60 of generating a command for controlling the robot according to the bidirectional trajectory when the S50 of calculating the forward trajectory is repeated a preset number of times.

In addition, in the S40 of determining whether or not the connection trajectory exists, when the connection trajectory exists, a forward time index is set for the connection trajectory and the backward trajectory, whether or not an inevitable collision state is present in the connection trajectory and the backward trajectory is determined, and if not, a time parameter of the forward trajectory, a time parameter of the backward trajectory, and a time parameter of the forward trajectory passing through a subsequent waypoint are changed by calculation.

In addition, according to an embodiment of the present invention, there is provided a computer-readable recording medium storing a program for employing an online bidirectional trajectory planning method in a state-time space.

In addition, according to an embodiment of the present invention, there is provided a program stored in a computer-readable recording medium, wherein the program is for employing an online bidirectional trajectory planning method in a state-time space.

According to an online bidirectional trajectory planning method in a state-time space, a recording medium storing a program for employing the same, and a computer program stored in a medium for employing the same according to an embodiment of the present invention, over-run or vibration of the robot can be minimized and at the same time trajectory calculation in real time can be available by planning a bidirectional trajectory using a forward trajectory and a backward trajectory.

In addition, an amount of calculation required for trajectory calculation can be reduced by applying a function decomposition-based cost minimizing algorithm that decomposes a cost-to-go function so as to reduce an amount of calculation.

In addition, an amount of calculation required for trajectory calculation can be reduced by calculating a trajectory on the basis of a safe timed configuration region Qₙ^{safe} (m).

In addition, a trajectory that smoothly passes through a target waypoint can be generated by calculating a forward trajectory prior to calculating a backward trajectory when setting a waypoint, calculating the backward trajectory, calculating the forward trajectory, and generating a robot control command.

In addition, a forward trajectory and a backward trajectory can be connected while the robot does not receive an over load by using a connection trajectory connecting the forward trajectory and the backward trajectory.

In addition, a required amount of calculation for trajectory can be reduced by determining a connection trajectory between calculating a backward trajectory and calculating a forward trajectory.

In addition, when a connection trajectory exists, a forward time index is set for the connection trajectory and a backward trajectory, and thus a secure trajectory can be generated by determining whether or not collision with dynamic obstacles is present in a connection trajectory and a backward trajectory, which were not considered before when performing calculation.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view of a flowchart showing a method of planning online bidirectional trajectory in state-time space according to an embodiment of the present invention.

FIG. 2 is a view of a flowchart showing a method of planning online bidirectional trajectory in state-time space according to another embodiment of the present invention.

FIG. 3 is a view of a flowchart showing a method of planning online bidirectional trajectory in state-time space according to still another embodiment of the present invention.

### DETAILED DESCRIPTION OF THE DISCLOSURE

The present invention can be modified in various manners and have various forms. Therefore, specific embodiments will be described in detail with reference to the accompanying drawings. However, the present invention is not limited to the specific embodiments, but may include all modifications, equivalents and substitutions within the scope of the present invention.

It will be understood that when an element is referred to as being “connected” or “coupled” to another element, it can be directly connected or coupled to the other element or intervening elements may be present.

In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises”, “comprising”, “includes”, and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Herein, with reference to the accompanying drawings, embodiments of the present invention will be described in detail. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. In addition, technical terms and scientific terms used in the present specification have the general meaning understood by those skilled in the art to which the present invention pertains unless otherwise defined, and a description for the known function and configuration obscuring the present invention will be omitted in the following description and the accompanying drawings. The drawings to be provided below are provided by way of example so that the idea of the present invention can be sufficiently delivered to a person skilled in the art to which the present invention pertains. Therefore, the present invention is not limited to the drawings provided below but may be modified in many different forms. In addition, like reference numerals designate like elements throughout the specification. In the drawings, same reference numerals denote same components throughout the disclosure.

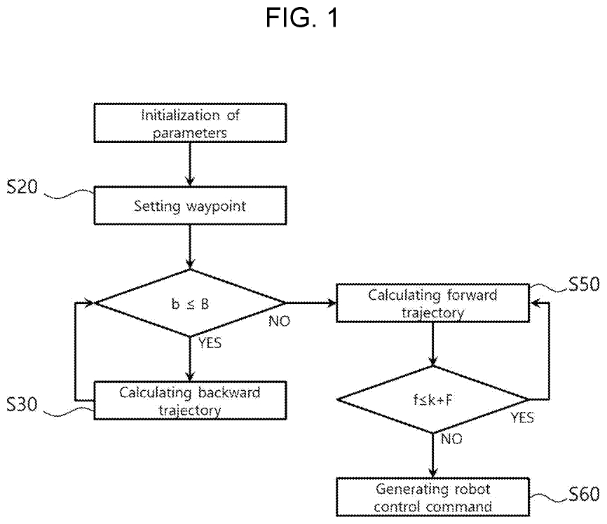

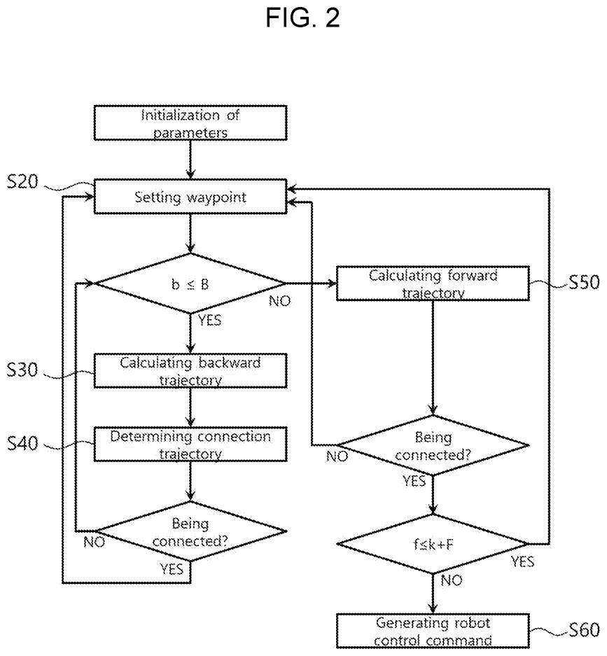

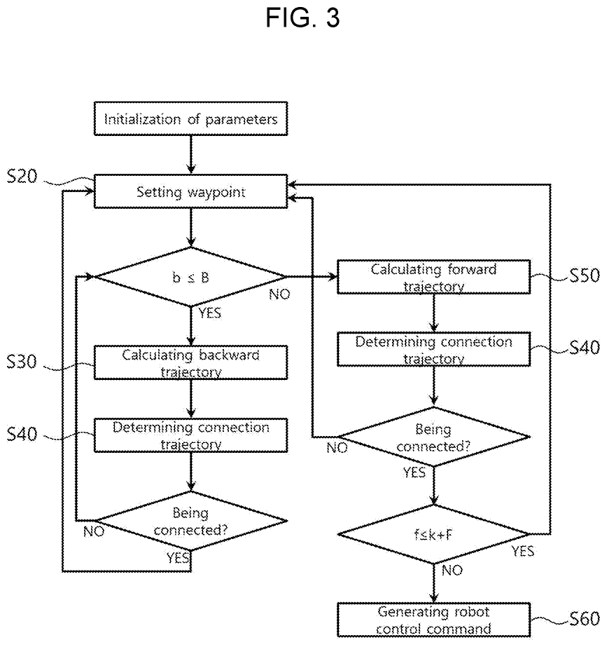

FIG. 1 is a view of a flowchart showing a method of planning online bidirectional trajectory in state-time space according to an embodiment of the present invention, FIG. 2 is a view of a flowchart showing a method of planning online bidirectional trajectory in state-time space according to another embodiment of the present invention, and FIG. 3 is a view of a flowchart showing a method of planning online bidirectional trajectory in state-time space according to still another embodiment of the present invention.

Prior to the description, terms used in the present specification (and claims) will be briefly described.

A “state-time space” refers to a set of state values taking into account of time.

A “state value” refers to a configuration value including a location and a bearing (heading angle), and includes any one or a plurality of pieces of information selected from a steering angle, a velocity (linear velocity, angular velocity), and an acceleration. For example, the same may be (x coordinate, y coordinate, bearing, velocity, acceleration), etc.

A “timed configuration region” means a set of configuration values taking into account time.

A “configuration value” refers to a value including a location, and a bearing (heading angle). For example, the same may be (x coordinate, y coordinate, bearing), etc.

A “waypoint” refers to a designated location trough which a robot passes when calculating a driving trajectory.

For the description, various parameters and terms are designated and described. The variables and terms are as below.

A state value of a current location of the robot is represented as “sₖ”.

A state value at a step f calculated in a forward trajectory from a current location of the robot is represented as “s_{f}”.

A state value of the robot when the robot arrives at a current target waypoint is represented as “g_{w}” A state value calculated for a step b in a backward trajectory from the current target waypoint is represented as “s_{-b}”.

A time index representing to which step corresponds the calculation is represented as “n”.

A time interval given for calculating one step is represented as “T”.

A time at a time index n is represented as “t” (t=nT).

A state value of the robot is represented as “s” (lowercase s).

A state space that is a set of state values of the robot is represented as “S” (capital letter S).

A timed state value that is a state value at a time step n is represented as sₙ (lowercase s).

A state-time space is represented as “Sₙ” (sₙϵSₙ).

A configuration value of the robot is represented as “q” (lowercase q).

A configuration region that is a set of configuration values of the robot is represented as “Q” (capital letter Q).

A timed configuration value that is a configuration value at a time step n is represented as qₙ(lowercase q).

A timed configuration region is represented as “Qₙ” (qₙϵQₙ).

A configuration region where collision with static obstacles exists is represented as Q^{env}.

A free static configuration region where collision with static obstacles does not exist is represented as Q^{free} (Q^{free}=Q−Q^{env}).

A configuration region where collision with dynamic obstacle exists at a time index n is represented as Qₙ^{obs}.

A free dynamic configuration region where collision with static obstacles and dynamic obstacles is not present is represented as Qₙ^{free} (Qₙ^{free}=Q^{free}−Qₙ^{obs}).

A state where collision is inevitable is referred to as an “inevitable state”.

Fundamental parameters and terms are summarized, but not all of the parameters and terms necessary for the description are listed. Parameters and terms that are used in addition to the parameters and terms defined above will be described later.

Hereinafter, in the description, description will be made assuming that the robot moves from a current state point corresponding to a state value sₖ to a target point (current target waypoint) corresponding to a state value g_{w}.

In an online bidirectional trajectory planning method in a state-time space according to an embodiment of the present invention, for an online bidirectional trajectory planning method in a state-time space, wherein the method is employed in a program form executed by an arithmetic processing means including a computer, a bidirectional trajectory is planned where a forward trajectory and a backward trajectory are incrementally planed (calculated). Herein, a state value sₙ (n represents time index, and is a natural number)) in a state-time space which is used for a planning forward trajectory and a backward trajectory includes a configuration value of a location and a bearing (heading angle), and includes any one or a plurality of pieces of information selected from a steering angle, a velocity (linear velocity, angular velocity), and acceleration.

In forward trajectory calculation, a forward trajectory in a state-time space is calculated from a current location of a robot or a last calculation point of a forward trajectory to a current target waypoint or a last calculation point of a backward trajectory by taking into account a state value s and a time value.

Herein, the time value is a value through which a future time from the current time is confirmed. For the same, a time index n may be used, but various methods may be used when an actual progress time can be confirmed such as multiplying a calculation period that calculates one step with a time index n (calculation period*time index n), etc.

In the forward trajectory calculation, a forward trajectory in a state-time space is calculated from an initial current location of the robot to a current target waypoint. Subsequently, when a forward trajectory and a backward trajectory are calculated, a forward trajectory in a state-time space may be calculated from a last calculation point of the forward trajectory toward a last calculation point of the backward trajectory.

In backward trajectory calculation, a backward trajectory in a state-time space is calculated from a current target waypoint or a last calculation point of a backward trajectory toward a current location of the robot or a last calculation point of a forward trajectory.

In the backward trajectory calculation, a backward trajectory in a state-time space may be calculated from an initial current target waypoint to a current location of the robot. Subsequently, when a forward trajectory and a backward trajectory are calculated, a forward trajectory in a state-time space may be calculated from a last calculation point of the backward trajectory to a last calculation point of the forward trajectory.

In other words, the forward trajectory calculation and the backward trajectory calculation are planned to head the opposite last calculation point.

Planning a backward trajectory allows the robot to pass more smoothly when the robot passes the target waypoint, and to reduce an over-run phenomenon where a turning trajectory becomes large when the robot turns on the target waypoint and then turns toward the next target waypoint as a distance between waypoints is short or an angle between waypoints is small.

In an online bidirectional trajectory planning method in state-time space according to an embodiment of the present invention, in the forward trajectory calculation and the backward trajectory calculation, a cost-to-go function H is decomposited, and a priority r (r is a natural number) is assigned to the decomposited cost-to-go function H^{r}.

The decomposited cost-to-go function is applied to a near-optimal timed state function N according to a preset reference which calculates a trajectory where a value of summing the decomposited cost-to-go function H^{r} becomes minimum (a r* value may be set or calculated).

Herein, a state value sₙ₊ₘ in a step where the number m of steps to be calculated is progressed from the given point of the state value sₙ toward the target point s^{to} is calculated on the basis of a given state value sₙ in an n (n is natural number) step, a state value s^{to} at a target point, and a number m of steps to be calculated.

Herein, a weighting factor is assigned to each decomposited cost function H^{r}, and a near-optimal timed state function N may be applied so as to calculate a trajectory so that the sum of values obtained by respectively multiplying the weight and decomposited cost functions H^{r} becomes minimum.

Alternatively, in an online bidirectional trajectory planning method in a state-time space according to an embodiment of the present invention, in the forward trajectory calculation and the backward trajectory calculation, a cost-to-go function H is decomposited, and a priority r (r is natural number) is assigned to the decomposited cost-to-go function H^{r}.

The decomposited cost-to-go functions H^{r} are sequentially applied to a near-optimal timed state function N according to the priority (an r* value may be set or calculated) which calculates a trajectory where each value of the decomposited cost functions H^{r} becomes minimum.

Herein, a state value sₙ₊ₘ in a step where the number m of steps to be calculated is progressed from the given point of the state value sₙ toward the target point s^{to} is calculated on the basis of a state value sₙ given in an n step, a state value s^{to} at a target point and a number m of steps to be calculated.

When planning the state value sₙ₊ₘ including the given state value sₙ, a cost-to-go from the state value sₙ₊ₘ to a point corresponding to the state value s^{to} is calculated to be minimum.

In other words, the forward trajectory calculation and the backward trajectory calculation may be defined as below.

$${s}_{n + m} = {argmin}_{s ∈ {S}_{n}^{safe} ( m )} H ( s , {s}^{to} ) H ( s , {s}^{to} )$$

Herein, sₙ₊ₘ is a state value at a time n+m, H is a cost-to-go function, s is a given state value, s^{to} is a state value at a target point, and m is a number of steps to be calculated.

When a cost-to-go function H is used, long time is required for calculation, and thus applying in real time to trajectory calculation is difficult.

An input value uₙ for the robot may be obtained as below.

$${u}_{n} = {argmin}_{u ∈ {\overline{U}}_{n} ( m )} {H}_{Input} ( {s}_{n} , {s}_{n + m} )$$

$${\overline{U}}_{n} ( m ) = \{ u ∈ U \vert {s}_{n + m} = g ( {s}_{n} , u , m ) {s}_{n + m} = {argmin}_{s ∈ {S}_{n}^{safe} ( m )} H ( s , {s}^{to} ) \}$$

Herein, Hᵢₙₚᵤₜ is a given cost cost-to-go function about input for the least effort.

The available input is always present since planning is performed for sₙ₊ₘ within a safe region that is bounded by the available input space of the available robot.

When the cost-to-go function for minimizing the cost-to-go is too complex to calculate a trajectory in real time, a function decomposition-based optimization method may be used.

A function decomposition-based optimization method decomposes a function into simple parts, and minimizes a dominant part first. It is assumed that H is configured with R parts as below.

$$H = {\sum }_{r = 1 , 2 , … , R} {H}^{r}$$

Herein H^{r}s are arranged in order of dominance. In other words, H^{r} with smaller r is more dominant. When minimizing is performed sequentially one by one from H¹ to H^{R}, an available safe region becomes smaller. The decomposited cost-to-go function H^{r} is minimized by increasing the r value until a single state value is induced.

A safe-timed state space Ŝₙ^{r}(m) that minimizes r parts from H¹ to H^{r} may be defined as below.

$${\hat{S}}_{n}^{r} ( m ) = \{ s {\vert argmin}_{s ∈ {\hat{S}}_{n}^{r - 1} ( m )} ( {H}^{r} ( s , {s}^{to} ) ) \}$$

A safe-timed state space Ŝₙ^{o}(m) calculated by using a cost-to-go function that is not decomposited is identical to a safe-timed state space Sₙ^{safe}(m).

An r value from which one state value is induced is referred to as r*, and minimizing is performed for the decomposited cost-to-go function until r* is obtained. Herein, a usable safe-timed state space is reduced to a single state as below.

{sₙ₊ₘ}=Ŝₙ^{r}*(m)

Herein,

r*=min{rϵ{1,2, . . . ,R}∥Ŝₙ^{r}(m)|=1}

Even though the timed state value obtained from function decomposition-based minimization does not minimize H, the result is close to minimum as dominant parts are minimized.

In addition, real time execution is available, and calculation is efficient.

Accordingly, when a near-optimal timed state function N is applied, forward trajectory calculation and backward trajectory calculation may be performed as below.

sₙ₊ₘ=N(sₙ,s^{to},m)

Herein, sₙ₊ₘ is a state value in an n+m step, N is a near-optimal timed state value calculation function, sₙ is a given state value in an n step, and s^{to} is a state value at a target point, and m is a number of steps to be calculated.

In case of an omnidirectional movable robot, for example, the near-optimal timed state function N may be calculated by using the equation below.

$$H ( {s}^{from} , {s}^{to} ) = {H}^{1} + {H}^{2} + {H}^{3}$$

$${H}^{1} = ‖ {p}^{from} - {p}^{to} ‖$$

$${H}^{2} = \vert {φ}^{from} - ϕ \vert + \vert {φ}^{to} - ϕ \vert$$

$${H}^{3} = \vert \frac{{v}^{from} D}{{v}_{ma x} min ( D , ‖ {p}^{from} - {p}^{to} ‖ )} - \frac{π - \vert {φ}^{from} - ϕ \vert}{π} \vert + \vert \frac{{v}^{to} D}{{v}_{ma x} min ( D , ‖ {p}^{from} - {p}^{to} ‖ )} - \frac{π - \vert {φ}^{to} - ϕ \vert}{π} \vert$$

Herein, H¹ is a velocity independent cost-to-go function, H² is a moving direction part cost-to-go function, and H³ is a velocity magnitude part cost-to-go function.

In order to induce the robot to move toward the target fast and pass through waypoints effectively, a cost-to-go function H(s^{from}, s^{to}) is configured with three parts, and D is a predefined threshold distance.

Each location in a reachable region is matched 1:1 with an admissible velocity space, and thus each timed state is determined on the basis of the velocity-independent cost-to-go function H¹.

The moving direction part cost-to-go function H² and the velocity magnitude part cost-to-go function H³ are used for setting a state of a current target waypoint.

On the basis of H¹, each timed configuration is determined to be the closest one to the target.

H² and H³ are designed for setting a state of the current target waypoint.

A velocity at the current target waypoint is determined by taking account into a robot location, a location of a target waypoint, and a location of a subsequent waypoint.

A direction is determined as an average direction of two vectors which are from a robot location to a location of a target waypoint, and from a location of a waypoint to a location of a subsequent waypoint.

In addition, a magnitude of a velocity at a target waypoint is determined according to an interior angle of a trajectory at the target waypoint.

When the angle is large, the velocity becomes fast, or vice versa.

When an Euclidean distance between a robot location and a location of a target waypoint or between a location of the target waypoint and a location of a subsequent waypoint is smaller than D, a magnitude of a velocity of the current target waypoint is set proportional to the distance in order to not oscillate near the waypoint.

In case of a robot moving through wheels, for example, the near-optimal timed state function N may be calculated by using the equation below.

$$H ( {s}^{from} , {s}^{to} ) = {H}^{1} + {H}^{2} + {H}^{3}$$

$${H}^{1} = α ( ‖ {p}^{from} - {p}^{to} ‖ ) + ( 1 - α ) ( \vert {θ}^{from} - ϕ \vert + \vert {θ}^{to} - ϕ \vert )$$

$${H}^{2} = \vert \frac{{v}^{from} D}{{v}_{ma x} min ( D , ‖ {q}^{from} - {q}^{to} ‖ )} - \frac{π - \vert {θ}^{from} - ϕ \vert}{π} \vert + \vert \frac{{v}^{to} D}{{v}_{ma x} min ( D , ‖ {q}^{from} - {q}^{to} ‖ )} - \frac{π - \vert {θ}^{to} - ϕ \vert}{π} \vert$$

$${H}^{3} = \vert \frac{{ω}^{from}}{{ω}_{ma x}} - \frac{ϕ - {θ}^{from}}{π} \vert$$

Herein, H¹ is a velocity-independent cost-to-go function, H² is a moving direction pat cost-to-go function, and H³ is a velocity magnitude part cost-to-go function.

As the example of the omnidirectional movable robot, each timed state is determined on the basis of the velocity-independent cost-to-go function H¹.

In order to take into account both of a location close to a target location and a direction to the target location, H¹ is configured with two parts with a predefined weighting factor α.

The moving direction pat cost-to-go function H² and the velocity magnitude part cost-to-go function H³ are used for setting a linear and angular velocity of a current target waypoint similar to the case of the omnidirectional movable robot.

In an online bidirectional trajectory planning method in a state-time space according to an embodiment of the present invention, for forward trajectory calculation, when a safe timed configuration region Qₙ^{safe} (m) exists which is a space within a configuration region where collisions with static obstacles and dynamic obstacles are not present, a forward trajectory is calculated on the basis of a configuration value qₙ of the robot at a time index n and a safe timed configuration region Qₙ^{safe} (m) at a time index n.

In the backward trajectory calculation, when the safe timed configuration region exists, a backward trajectory is calculated on the basis of a configuration value qₙ of the robot at a time index n and the safe timed configuration region Qₙ^{safe} (m).

When a set of configuration values where collision with static environmental obstacles such as wall exists is referred to as Q^{env} and as “environmental obstacle configuration region” (Q^{env}⊂Q), difference of sets obtained by subtracting the environmental obstacle configuration region Q^{env} from the configuration region Q may be referred to as a “free static configuration region” Q^{free}.

The robot may predict a trajectory of each dynamic obstacle such as people and other robots on the basis of a tracking algorithm using sensor data.

Accordingly, when a set of configuration values predicted to collide with any dynamic obstacles such as people at a time index n is referred to as Qₙ^{obs} and as a dynamic obstacle space “(Qₙ^{obs}⊂Q), difference of sets obtained by subtracting the dynamic obstacle space Qₙ^{obs} from the free static configuration region Q^{free} may be referred to as a “free dynamic configuration region” Qₙ^{free}.

In other words, the free dynamic configuration region Qₙ^{free} at a time index n may be a safe region where the robot does not collide with obstacles including dynamic obstacles and static obstacles at a time index n.

A motion of a robot system with an input value uₙ(uₙϵU) in an input space U at a time index n may be defined as below.

sₙ₊₁=f(sₙ,uₙ)

Herein, f is a motion model function of a robot.

A state space S of the robot and an input space U of the robot are bounded, and thus robot motion is constrained which is referred to a motion constraint.

Environment detectors (sensors) detect and track obstacles on the basis of a sensory system using sensors, such as vision sensors or laser range finders (LRF), etc., and classify the same into static obstacles (environmental obstacles) and dynamic obstacles (non-environmental obstacles) to obtain Q^{env} and Qₙ^{obs}.

Global trajectory planner (global path planner) planning a trajectory by assigning a waypoint plans a sequence of waypoints and a target inside a free static configuration region Q^{free}.

At every time instant t=kT, k=0, 1, . . . , an algorithm plans a trajectory by using a reference input k.

By the above input, the robot passes through waypoints sequentially and arrive the target without any collision by using both of Q^{env} and Qₙ^{obs}.

When a timed state value sₙ is given, a reachable state-time region at a time index n+m may be defined. Herein, a reachable timed configuration region may be also defined.

In order to plan a trajectory in real time, it is preferable to reduce an amount of calculation by approximating the reachable state-time region or timed configuration region.

It may be difficult to perform real time calculation when the reachable state-time region or timed configuration region is calculated accurately and used.

In order to simplify the reachable region, the robot may be controlled for m time steps by using a uniform robot input value.

A reachable state-time region that is reachable by the uniform robot input value may be defined as below.

Sₙ(m)={sₙ₊ₘϵS|∀uₙϵU,sₙ₊ₘ=g(sₙ,uₙ,m)}

Herein, g is an approximated motion model function of a robot.

Herein, a reachable timed configuration region that is reachable by the uniform input value of the robot may be defined as below.

$${Q}_{n} ( m ) = \{ {q}_{n + m} ∈ Q \vert ∀ {u}_{n} ∈ U , {s}_{n + m} = g ( {s}_{n} , {u}_{n} , m ) , {s}_{n + m} ∈ S \}$$

Sₙ (m) and Qₙ (m) do not cover the whole actual reachable region, but calculation load is very small rather than calculating the whole actual reachable region, and thus the same are useful for trajectory planning.

When a state value sₙ is given, a safe-timed state space Sₙ^{safe} (m) at a time index n+m may be defined as below.

Sₙ^{safe}(m)=Sₙ(m)∩Sₙ₊ₘ^{free},(n>0,m>0)

In addition, when a state value sₙ is given, a safe timed configuration region Qₙ^{safe} (m) at a time n+m may be defined as below.

Qₙ^{safe}(m)=Qₙ(m)∩Qₙ₊ₘ^{free},(n>0,m>0)

Qₙ^{safe} (m) is planned within Sₙ^{safe} (m), but using Qₙ^{safe} (m) may be enough by checking predicted collision and by check whether or not an available safe region exists.

When calculating the safe timed configuration region Qₙ^{safe} (m) of a backward trajectory at a current target waypoint, Qₙ₊ₘ^{free} is replaced with Q^{free}.

This is because, an actual time of Qₙ₊ₘ^{free} is not given, and thus data of dynamic obstacles is not obtained.

As shown in FIG. 1, an online bidirectional trajectory planning method in a state-time space according to an embodiment of the present invention may include S20 of setting a waypoint, S30 of calculating a backward trajectory, S50 of calculating a forward trajectory, and S60 of generating a robot control command.

In S20 of setting a waypoint, a robot state at a current target waypoint is set.

The current target waypoint is a waypoint where a forward trajectory is heading to pass through.

The S20 of setting a waypoint is setting a robot state when the robot passes the current target waypoint. It is preferable to set the robot state when the robot passes the current target waypoint by taking into account of a robot location, a location of a target waypoint, and a location of a subsequent waypoint.

Accordingly, in the S20 of setting a waypoint is setting a waypoint where the forward trajectory passes through the current target waypoint, a state value g_{w} of the current target waypoint is set as an equation below so as to minimize a cost-to-go.

$$[ {g}_{w} {\tilde{g}}_{w + 1} ] = {argmin}_{[ g \hat{g} ] ∈ {G}_{w} \times {G}_{w + 1}} ( H ( {s}_{f} , g ) + H ( g , \tilde{g} ) )$$

Herein, g_{w} represents a state value of a current target waypoint, \tilde{g}_{w+1} represents a state value of a subsequent target waypoint while setting g_{w}, G_{w} represents a state range of the current target waypoint, G_{w+1} represents a state range of the subsequent target waypoint, H(a, b) represents a cost-to-go function from a to b, S_{f} represents a current location of a robot, grepresents the current target waypoint, and \tilde{g} represents a subsequent waypoint of the current target waypoint.

In S30 of calculating a backward trajectory, a backward trajectory is calculated.

The S30 of calculating a backward trajectory plans a trajectory from the current target waypoint to a current location of the robot. Herein, when the forward trajectory is calculated, a backward trajectory to a last calculation point of the forward trajectory may be calculated.

A parameter B of the first conditional statement shown in FIG. 1 means a maximum value of time steps required for backward trajectory planning, a parameter b means a time step (increased by 1 when repeatedly calculated) of the backward trajectory planning. However, various methods may be used by arbitrarily setting parameters and conditions therefor. (The same is applied to parameters shown in FIGS. 2 and 3.)

The S50 of calculating of a forward trajectory calculates a forward trajectory.

In the S50 of calculating a forward trajectory, a trajectory is planned to a target waypoint from the current location of the robot. Herein, when the backward trajectory is calculated, a forward trajectory may be calculated to a last calculation point of the backward trajectory.

A parameter F of the second conditional statement shown in FIG. 1 means a maximum value of time steps required for forward trajectory planning, and a parameter f means a time step of the backward trajectory planning (increased by 1 when repeatedly calculated), and k means a current time step. However, various methods may be used by arbitrarily setting parameters and conditions therefor. (The same is applied to parameters shown in FIGS. 2 and 3.)

The S30 of calculating a backward trajectory and the S50 of calculating a forward trajectory may be performed in reverse order. It is preferable to perform the S30 of calculating a backward trajectory first so as to generate a trajectory to smoothly pass through a target waypoint.

The S30 of calculating a backward trajectory and the S50 of calculating a forward trajectory may be alternately repeated. Various methods of repeating one of the S30 of calculating a backward trajectory and the S50 of calculating a forward trajectory may be repeated a preset of times first, and then repeating the other one may be used to repeat the S30 of calculating a backward trajectory and the S50 of calculating a forward trajectory.

As a result, the S30 of calculating a backward trajectory and the S50 of calculating a forward trajectory are completed when the backward trajectory and the forward trajectory are connected from a current location to a current target waypoint so as to complete bidirectional trajectory planning.

The S60 of generating a robot control command generates a command for controlling the robot according to the bidirectional trajectory when the S30 of calculating a backward trajectory and the S50 of calculating a forward trajectory are repeated a preset number of times.

Most of the robot control commands are generated according to the forward trajectory.

This is because a real time bidirectional trajectory is planned when calculation for a new bidirectional trajectory has to be completed before the robot completes moving one time step.

An input value for the robot generated in the S60 of generating a robot control command may be calculated as below.

$${u}_{k} = {argmin}_{u ∈ {\overline{U}}_{k} ( 1 )} {H}_{Input} ( {s}_{k} , {s}_{k + 1} )$$

Herein, uₖ is an input value for a robot at a time k, uϵŪₖ(1) is an input value for the robot which is included in an input space of the robot at a k-th step where one step may be run, Hᵢₙₚᵤₜ is a minimum cost-to-go function for an input value of the robot, Sₖ is a state value of the robot at a time k, and sₖ₊₁ is a state value of the robot at a time k+1.

In an online bidirectional trajectory planning method in a state-time space according to an embodiment of the present invention, a connection trajectory is calculated so as to connect the forward trajectory and the backward trajectory, and planning is performed for a bidirectional trajectory that incrementally plans a forward trajectory and a backward trajectory.

When a bidirectional trajectory is continuously planned, a forward trajectory and a backward trajectory may meet, but a velocity may vary.

Accordingly, in order to overcome a velocity difference between the forward trajectory and the backward trajectory, it is preferable to connect the forward trajectory and the backward trajectory by using the connection trajectory.

In other words, it is preferable to calculate a connection trajectory, in which a first side of the connection trajectory connected to the forward trajectory, is calculated to have a velocity identical to a velocity of a last calculation point of the forward trajectory, and a second side of the connection trajectory connected to the backward trajectory is calculated to have a velocity identical to a velocity of a last calculation point of the backward trajectory.

Herein, in order to simplify calculation, calculation of a connection trajectory which is a section between a last calculated state value s_{f} of the forward trajectory and a last calculated state value s_{-b} of the backward trajectory may be performed by using the same input value for the robot as the equation below.

$${s}_{f + {c}_{1}} = f ( {s}_{f} , {u}_{f} , {c}_{1} )$$

$${s}_{f + {c}_{1} + {c}_{2}} = f ( {s}_{f + {c}_{1}} , {u}_{f + {c}_{1}} , {c}_{2} )$$

$$⋮$$

$${s}_{- b} = f ( {s}_{f + {c}_{1} + … + {c}_{N}} , {u}_{f + {c}_{1} + … + {c}_{N}} , {c}_{N} )$$

Herein, f(a, b, c) is a motion model function of a robot which calculates a state value of the robot moving from a point corresponding to a state value by a time step c according to an input value for the robot.

When a maximum time interval used when calculating a connection trajectory is C, the same becomes (c₁+ . . . +c_{N})≤C.

As shown in FIG. 2, an online bidirectional trajectory planning method in a state-time space according to an embodiment of the present invention may include S20 of setting a waypoint, S30 of calculating a backward trajectory, S40 of determining a connection trajectory, S50 of calculating a forward trajectory, and S60 of generating a robot control command.

In S20 of setting a waypoint, a robot state at a current target waypoint is set. The current target waypoint is a waypoint where a forward trajectory is heading to pass through.

The S20 of setting a waypoint is setting a robot state when the robot passes the current target waypoint. It is preferable to set the robot state when the robot passes the current target waypoint by taking into account of a robot location, a location of a target waypoint, and a location of a subsequent waypoint.

Accordingly, in the S20 of setting a waypoint is setting a waypoint where the forward trajectory passes through the current target waypoint, a state value g_{w} of the current target waypoint is set as the equation below so as to minimize the cost-to-go.

$$[ {g}_{w} {\overline{g}}_{w + 1} ] = {argmin}_{[ g \tilde{g} ] ∈ {G}_{w} \times {G}_{w + 1}} ( H ( {s}_{f} , g ) + H ( g , \overline{g} ) ) .$$

Herein, g_{w} represents a state value of a current target waypoint, \tilde{g}_{w+1} represents a state value of a subsequent target waypoint while setting g_{w}, G_{w} represents a state range of the current target waypoint, G_{w+1} represents a state range of the subsequent target waypoint, H(a, b) represents a cost-to-go function from a to b, S_{f} represents a current location of a robot, g represents the current target waypoint, and \tilde{g} represents a subsequent waypoint of the current target waypoint.

In S30 of calculating a backward trajectory, a backward trajectory is calculated.

The calculating of the backward trajectory, S30, plans a trajectory from the current target waypoint to a current location of the robot. Herein, when the forward trajectory is calculated, a backward trajectory to a last calculation point of the forward trajectory may be calculated.

The S30 of calculating a backward trajectory may calculate a backward trajectory step by step, or may calculate on a per predetermined step basis.

In the S40 of determining a connection trajectory, whether or not a connection trajectory where a current location of the robot or a last calculation point of a forward trajectory is connected to a current target waypoint or a last calculation point of a backward trajectory exists is determined.

The S40 of determining a connection trajectory may be performed whenever one step of the backward trajectory is calculated, or whenever a predetermined number of steps of the backward trajectory is calculated.

Herein, when a connection trajectory is not present in the S40 of determining a connection trajectory, from the S30 of calculating a backward trajectory to the S40 of determining a connection trajectory may be repeated a preset number of times, and when a connection trajectory is determined in the S40 of determining a connection trajectory, returning to the S20 of setting a waypoint is performed.

In other words, whenever a backward trajectory is calculated for one step, whether or not a connection trajectory exists is determined, and if not, a backward trajectory is calculated for a preset number of times.

Planning a backward trajectory prior to a forward trajectory allows the robot to pass more smoothly when passing the target waypoint, and reduces an over-run phenomenon where a turning trajectory becomes large when the robot turns on the target waypoint and then turns toward the next target waypoint as a distance between waypoints is short or an angle between waypoints is small.

In addition, calculating a backward trajectory for a preset number of times first also allows the robot to pass more smoothly when passing the target waypoint.

Herein, when the S30 of calculating a backward trajectory to the S40 of determining a connection trajectory are repeated a preset number of times, moving to the subsequent step is performed even though a connection trajectory is not present.

In the S50 of calculating a forward trajectory, a forward trajectory is calculated when a connection trajectory is determined to be not present in the S40 of determining a connection trajectory.

In the S50 of calculating a forward trajectory, a trajectory is planned to a current target waypoint from the current location of the robot. Herein, when the backward trajectory is calculated, a forward trajectory may be calculated to a last calculation point of the backward trajectory.

The S50 of calculating a forward trajectory may calculate a forward trajectory step by step, or may calculate on a per predetermined step basis.

The S60 of generating a robot control command generates a command for controlling the robot according to the bidirectional trajectory when the S50 of calculating a forward trajectory are repeated a preset number of times.

Most of the robot control commands are generated according to the forward trajectory.

This is because a real time bidirectional trajectory is planned when calculation for a new bidirectional trajectory has to be completed before the robot completes moving one time step.

An input value for the robot generated in the S60 of generating a robot control command may be calculated as below.

$${u}_{k} = {argmin}_{u ∈ {\overline{U}}_{k} ( 1 )} {H}_{Input} ( {s}_{k} , {s}_{k + 1} )$$

Herein, uₖ is an input value for a robot at a time k, uΣŪₖ(1) is an input value for the robot which is included in an input space of the robot at a k-th step where one step may be run, Hᵢₙₚᵤₜ is a minimum cost-to-go function for an input value of the robot, Sₖ is a state value of the robot at a time k, and sₖ₊₁ is a state value of the robot at a time k+1.

In an online bidirectional trajectory planning method in a state-time space according to an embodiment of the present invention, when a connection trajectory is determined to be present in the S40 of determining a connection trajectory, a forward time index is set for a connection trajectory and a backward trajectory, whether or not an inevitable collision state is present in the connection trajectory and the backward trajectory is determined, and then if not, a time parameter of a forward trajectory, a time parameter of a backward trajectory, and a time parameter of a forward trajectory passing through a subsequent waypoint are changed by calculation.

A forward time index applied to a forward trajectory may provide an absolute time (a time based on the robot). Accordingly, collision with dynamic obstacles may be predicted.

However, a backward time index applied to a backward trajectory and a time index applied to a connection trajectory do not provide an absolute time, and thus collision with dynamic obstacles may not be predicted.

Accordingly, when a forward trajectory, a connection trajectory, and a backward trajectory are connected, in order to determine whether or not collision with dynamic obstacles is present, a time index used in the connection trajectory and the backward trajectory has to be changed to a forward time index applied to the forward trajectory. Accordingly, an absolute time may be provided for the connection trajectory and the backward trajectory, and whether or not predicted collision is present in the backward trajectory and the connection trajectory may be determined.

When predicted collision is not present in the backward trajectory and the connection trajectory, a bidirectional trajectory is completed from the current location of the robot to the current target waypoint.

As above, an online bidirectional trajectory planning method in a state-time space according to an embodiment of the present invention has been described. However, a computer-readable recording medium on which a program for employing an online bidirectional trajectory planning method in a state-time space, and a program stored on a computer-readable recording medium for employing an online bidirectional trajectory planning method in a state-time space may be also feasible.

In other words, an online bidirectional trajectory planning method in a state-time space described above may be employed in the form of program instructions executable through diverse computing means and may be recorded in computer readable media. In other words, the method may be employed in the form of a program command that can be executed through various computer means, and can be recorded on a computer-readable recording medium. The computer readable media may include independently or associatively program instructions, data files, data structures, and so on. Program instructions recorded in the media may be specially designed and configured for embodiments, or may be generally known by those skilled in the computer software art. Computer readable recording media may include magnetic media such as hard disks and floppy disks, optical media such as CD-ROMs and DVDs, magneto-optical media such as floptical disks, and hardware units, such as ROM, RAM, flash memory, and so on, which are intentionally formed to store and perform program instructions. Program instructions may include high-class language codes executable by computers using interpreters, as well as machine language codes likely made by compilers. The hardware units may be configured to function as one or more software modules for performing operations according to embodiments of the present disclosure, and vice versa.

It will be understood by those skilled in the art that various changes in form and details may be made therein without departing from the spirit and scope of the invention as defined by the appended claims.

What is claimed is:

1. An online bidirectional trajectory planning method in a state-time space, wherein the method is employed in a program form executed by an arithmetic processing means including a computer, the method comprising:
planning a bidirectional trajectory on the basis of a forward trajectory calculation in a state-time space which is from a current location of a robot or a last calculation point of a forward trajectory to a current target waypoint or a last calculation point of a backward trajectory by taking into account a state value (s) and a time value, and a backward trajectory calculation in the state-time space which is from the current target waypoint or a last calculation point of the backward trajectory to the current location of the robot or the last calculation point of the forward trajectory,
wherein the forward trajectory and the backward trajectory are incrementally planned,
wherein a state value (sₙ) (n represents a time index, and is a natural number)) in the state-time space, which is used when planning the forward trajectory and the backward trajectory, includes a configuration value of a location and a bearing (heading angle), and includes any one or a plurality of pieces of information selected from a steering angle, a velocity, and an acceleration.

2. The method of claim 1, wherein in the forward trajectory calculation and the backward trajectory calculation, a cost-to-go function (H) is decomposited, and a priority r (r is natural number) is assigned to each decomposited cost-to-go function (H^{r}), and the decomposited cost-to-go functions (H^{r}) are applied according a preset reference (an r* value may be set or calculated) to a near-optimal timed state function (N) which calculates a trajectory such that a value of summing the decomposited cost-to-go functions (H^{r}) become minimum,
wherein a state value (sₙ₊ₘ) from a point where a state value (sₙ) is given to a target point is calculated where the calculation is performed for a number (m) of steps on the basis of the state value (sₙ) given in an n step, a state value (s^{to}) at the target point, and the number (m) of steps to be calculated.

3. The method of claim 1, wherein in the forward trajectory calculation and the backward trajectory calculation, a cost-to-go function (H) is decomposited, and a priority r (r is a natural number) is assigned to each decomposited cost-to-go function (H¹), and the decomposited cost-to-go functions (H^{r}) are sequentially applied according to a priority (an r* value may be set or calculated) to a near-optimal timed state function (N) which calculates a trajectory such that each value of the decomposited cost functions (H^{r}) become minimum,
wherein a state value (sₙ₊ₘ) from a point where a state value (sₙ) is given to a target point is calculated where the calculation is performed for a number (m) of steps on the basis of the state value (sₙ) given in an n step, a state value (s^{to}) at the target point, and the number (m) of steps to be calculated.

4. The method of claim 1, wherein in the forward trajectory calculation,
when a safe timed configuration region Qₙ^{safe} (m) exists which is a space within a configuration region where collisions with static obstacles and dynamic obstacles are not present, the forward trajectory is calculated on the basis of a configuration value (qₙ) of the robot a time index (n) and the safe timed configuration region Qₙ^{safe} (m) at the time index (n),
and in the backward trajectory calculation,
when the safe timed configuration region exists, the backward trajectory is calculated on the basis of the configuration value (qₙ) of the robot at the time index (n) and the safe timed configuration region Qₙ^{safe} (m).

5. The method of claim 1, wherein the planning of the bidirectional trajectory includes:
S20 of setting a robot state in a current target waypoint;
S30 of calculating the backward trajectory;
S50 of calculating the forward trajectory; and
S60 of generating a command for controlling the robot according to the bidirectional trajectory when the S30 of calculating the backward trajectory and the S50 of calculating the forward trajectory are repeated a preset number of times.

6. The method of claim 1, wherein further comprising:
calculating a connection trajectory connecting the forward trajectory and the backward trajectory,
wherein the bidirectional trajectory is planned by incrementally planning the forward trajectory and the backward trajectory after the calculating of the connection trajectory.

7. The method of claim 1, wherein the planning of the bidirectional trajectory includes:
S20 of setting a robot state in a current target waypoint;
S30 of calculating the backward trajectory;
S40 of determining whether or not the connection trajectory exists where the current location of the robot or the last calculation point of the forward trajectory is connected to the current target waypoint or the last calculation point of the backward trajectory;
S50 of calculating the forward trajectory when the connection trajectory does not exist; and
S60 of generating a command for controlling the robot according to the bidirectional trajectory when the S50 of calculating the forward trajectory is repeated a preset number of times.

8. The method of claim 7, wherein in the S40 of determining whether or not the connection trajectory exists,
when the connection trajectory exists, a forward time index is set for the connection trajectory and the backward trajectory,
whether or not an inevitable collision state is present in the connection trajectory and the backward trajectory is determined,
and if not, a time parameter of the forward trajectory, a time parameter of the backward trajectory, and a time parameter of the forward trajectory passing through a subsequent waypoint are changed by calculation.

9. A computer-readable recording medium storing a program for employing an online bidirectional trajectory planning method in a state-time space of claim 1.

10. A program stored in a computer-readable recording medium, wherein the program is for employing an online bidirectional trajectory planning method in a state-time space of claim 1.
